(19) United States
(12) Patent Application Publication
(10) Pub. No.: US 2013/0346888 A1
(43) Pub. Date: Dec. 26, 2013

(54) EXPOSING USER INTERFACE ELEMENTS ON SEARCH ENGINE HOMEPAGES

(71) Applicants: Joshua Edward SMITH, Bellevue, WA (US); Abhishek JHA, Bellevue, WA (US); Sarah K. BERRIER, Shoreline, WA (US); Rajeev CHAND, Redmond, WA (US)

(72) Inventors: Joshua Edward SMITH, Bellevue, WA (US); Abhishek JHA, Bellevue, WA (US); Sarah K. BERRIER, Shoreline, WA (US); Rajeev CHAND, Redmond, WA (US)

(73) Assignee: MICROSOFT CORPORATION, Redmond, WA (US)

(21) Appl. No.: 13/531,161

(22) Filed: Jun. 22, 2012

(51) Int. Cl. G06F 3/01

(52) U.S. Cl. 715/760

(57) ABSTRACT

Systems, methods, and computer-readable storage media for facilitating discoverability of user interface elements associated with search engine homepages are provided. When users navigate to a search engine homepage having a background image associated therewith and perform a specified action with respect thereto (for instance, moving a mouse pointer over the image, clicking on the image, or tapping on the image), a plurality of user interface elements is surfaced. Each user interface element is associated with information with which the user may be presented upon interaction with the element. Upon the user ceasing to perform the specified action (or upon the expiration of a predefined period of time), the user interface elements cease to be presented and the user is able to view the search engine homepage without the embedded information.

### BACKGROUND

The Internet, through its billions of Web pages, provides a vast and quickly growing library of information and resources. In order to find desired content, computer users often make use of search utilities. Exemplary Internet search engines are well known in the art, for instance, a commonly known commercial engine is the BING search engine provided by Microsoft Corporation of Redmond, Wash. With the increased usage of search utilities, search engines have begun to add features and functionality to their search engine homepages to provide users navigating to these utilities with a richer, more satisfying experience. One such feature is a background image that incorporates interactive functionality to permit users navigating to the search engine homepage to discover interesting information about the item pictured.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable storage media for, among other things, exposing hidden user interface elements associated with search engine homepages. When users navigate to a search engine homepage having a background image associated therewith and perform a specified action with respect thereto (for instance, moving a mouse pointer over the image, clicking on the image, tapping on the image, or the like), a plurality of user interface elements is surfaced. Each user interface element is associated with information with which the user may be presented upon interaction with the element. Upon the user ceasing to perform the specified action, or upon the expiration of a predefined period of time (e.g., a predefined period of user inactivity with respect to the search engine homepage), the user interface elements cease to be presented and the user is able to view the search engine homepage without the embedded information.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing an exemplary method for exposing hidden user interface elements associated with a search engine homepage, in accordance with an embodiment of the present invention;

FIG. 4 is a schematic diagram showing an exemplary screen display of a search engine homepage having a background image and exposed user interface elements, in accordance with an embodiment of the present invention;

FIG. 5 is a schematic diagram showing an exemplary screen display of a search engine homepage in which a user has performed a specified action with respect to one of the user interface elements of FIG. 4, in accordance with an embodiment of the present invention;

FIG. 6 is a schematic diagram showing an exemplary screen display of a search engine homepage in which a user has performed a specified action with respect to a different one of the user interface elements than that shown in FIG. 5, in accordance with an embodiment of the present invention; and

FIG. 7 is a flow diagram showing another exemplary method for exposing hidden user interface elements associated with a search engine homepage, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for, among other things, exposing hidden user interface elements associated with search engine homepages. When users navigate to a search engine homepage having a background image associated therewith and perform a specified action with respect thereto (for instance, moving a mouse pointer over the image, clicking on the image, tapping on the image, or the like), a plurality of user interface elements is surfaced. Each user interface element is associated with information with which the user may be presented upon interaction with the element. Upon the user ceasing to perform the specified action, or upon the expiration of a predefined period of time (e.g., a predefined period of user inactivity with respect to the search engine homepage), the user interface elements cease to be presented and the user is able to view the search engine homepage without the embedded information.

Accordingly, one embodiment of the present invention is directed to one or more computer-readable storage media storing computer-useable instructions that, when used by one or more computing devices, cause the one or more computing devices to perform a method for exposing hidden user interface elements associated with search engine homepages. The method includes presenting a search engine homepage having a background image associated therewith, detecting a first user action with respect to the presented search engine homepage and, upon detecting the first user action, presenting a plurality of user interface elements, each user interface element being associated with an additional information segment relevant to the background image.

In another embodiment, the present invention is directed to a system for facilitating discoverability of user interface elements associated with search engine homepages. The system comprises a computing device associated with a server having one or more processors and one or more computer-readable storage media, and a data store coupled with the server. The server is configured to detect a first user action with respect to a presented search engine homepage, the search engine homepage having an associated background image. Upon detecting the first user action, the server is further configured to present a plurality of user interface elements, each of the plurality of user interface elements being associated with an additional information segment relevant to the background image. The server is further configured to detect a second user action with respect to a particular user interface element of the plurality of user interface elements and, upon detecting the second user action, to present the additional information segments associated with each of the plurality of user interface elements.

In yet another embodiment, the present invention is directed to a method being performed by one or more computing devices including at least one processor, for exposing hidden user interface elements associated with search engine homepages. The method includes presenting a search engine homepage having a background image associated therewith, and detecting a first user action with respect to the presented search engine homepage. Upon detecting the first user action, the method further includes presenting a plurality of user interface elements, each user interface element being associated with an additional information segment relevant to the background image. The method further includes detecting a second user action over a region of the background image that is within a predefined proximity to a particular user interface element of the plurality of user interface elements. Upon detecting the second user action, the method further includes causing the plurality of user interface elements other than the particular user interface element to cease to be presented and presenting the additional information segment associated with the particular user interface element.

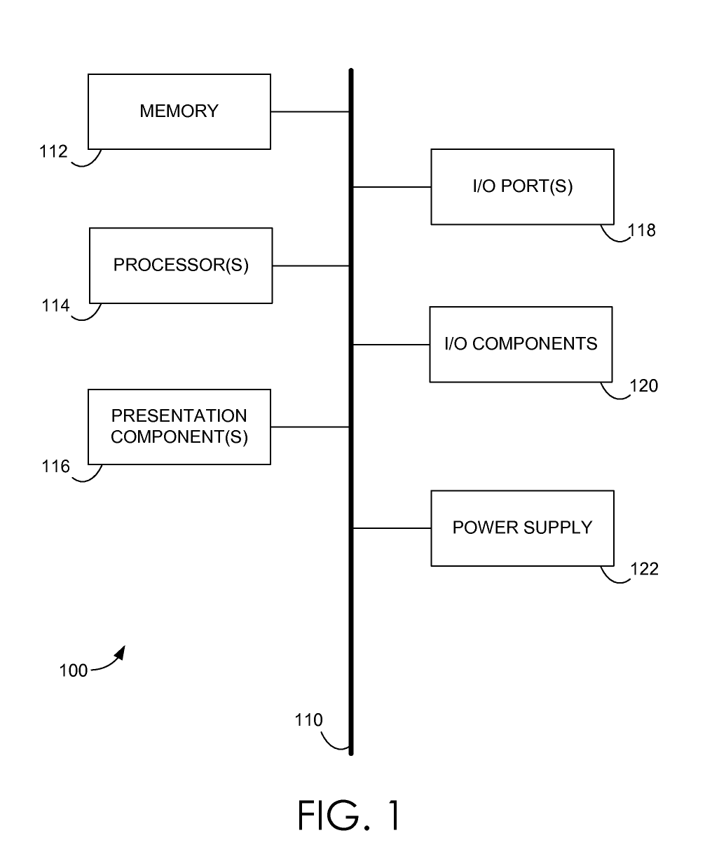

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including, but not limited to, hand-held devices, consumer electronics, general purpose computers, specialty computing devices, and the like. Embodiments of the invention may also be practiced in distributed computing environments where tasks are performed by remote processing devices that are linked through a communications network.

In a distributed computing environment, program modules may be located in association with both local and remote computer storage media including memory storage devices. The computer useable instructions form an interface to allow a computer to react according to a source of input. The instructions cooperate with other code segments to initiate a variety of tasks in response to data received in conjunction with the source of the received data.

With continued reference to FIG. 1, computing device 100 includes a bus 110 that directly or indirectly couples the following elements: memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. Thus, it should be noted that the diagram of FIG. 1 is merely illustrative of an exemplary computing device that may be used in connection with one or more embodiments of the present invention. Distinction is not made between such categories as “workstation,” “server,” “laptop,” “hand held device,” etc., as all are contemplated within the scope of FIG. 1 and reference to the term “computing device.”

The computing device 100 typically includes a variety of computer-readable media. Computer-readable media can be any available media that can be accessed by the computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer storage media in the form of volatile and/or nonvolatile memory. The memory may be removable, non-removable, or a combination thereof. Exemplary hardware devices include solid state memory, hard drives, optical disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components 120 include a microphone, joystick, game pad, satellite dish, scanner, printer, wireless device, etc.

As previously mentioned, embodiments of the present invention are generally directed to systems, methods, and computer-readable storage media for, among other things, exposing hidden user interface elements associated with search engine homepages. Upon user navigation to a search engine homepage having a background image associated therewith and performance of a specified action with respect thereto (for instance, moving a mouse pointer over the image, clicking on the image, tapping on the image, or the like), a plurality of user interface elements is surfaced. Each user interface element is associated with information with which the user may be presented upon interaction with the element. In embodiments, interaction with a particular user interface element causes the additional information segment (or at least a portion thereof) associated with the particular element to be presented and causes the remaining user interface elements to cease to be presented. In other embodiments, interaction with any one of the plurality of user interface elements causes the additional information segments associated with each of the plurality of user interface elements to be presented simultaneously. Any and all such variations, and any combination thereof, are contemplated to be within the scope of embodiments of the present invention.

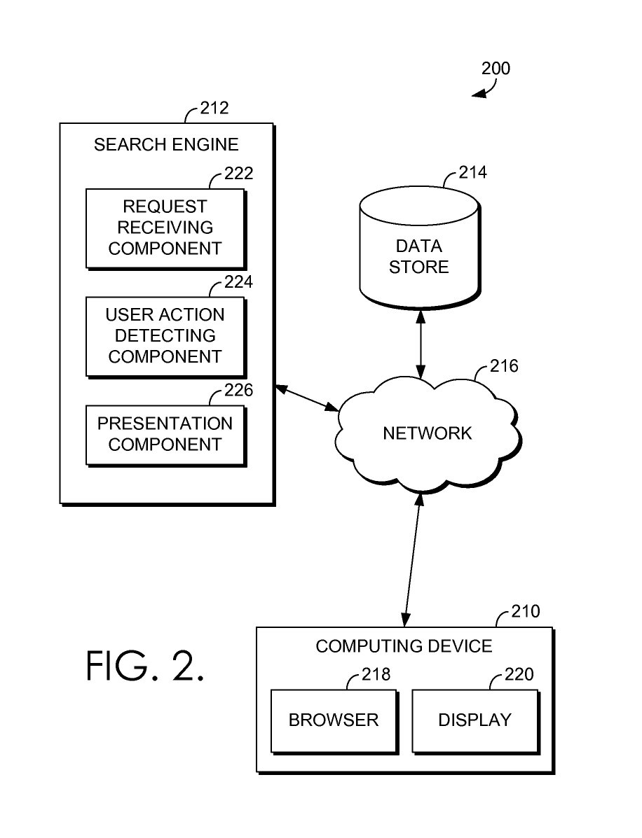

Referring now to FIG. 2, a block diagram is provided illustrating an exemplary computing system 200 in which embodiments of the present invention may be employed. Generally, the computing system 200 illustrates an environment in which hidden user interface elements associated with search engine homepages may be exposed. Among other components not shown, the computing system 200 generally includes a user computing device 210, a search engine 212, and a data store 214, all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

It should be understood that any number of user computing devices and search engines may be employed in the computing system 200 within the scope of embodiments of the present invention. Each may comprise a single device/interface or multiple devices/interfaces cooperating in a distributed environment. For instance, the search engine 212 may comprise multiple devices and/or modules arranged in a distributed environment that collectively provide the functionality of the search engine 212 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via the user computing device 210, as an Internet-based service, or as a module inside the search engine 212. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of search engines or user computing devices. By way of example only, the search engine 212 might be provided as a single server (as shown), a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 210 may include any type of computing device, such as the computing device 100 described with reference to FIG. 1, for example. Generally, the user computing device 210 includes a browser 218 and a display 220. The browser 218, among other things, is configured to render search engine home pages (or other online landing pages), and render search engine results pages in association with the display 220 of the client computing device 210. The browser 218 is further configured to receive user input of requests for various web pages (including search engine home pages), receive user inputted search queries (generally inputted via a user interface presented on the display 220 and permitting alpha-numeric and/or textual input into a designated search box) and to receive content for presentation on the display 220, for instance, from the search engine 212. It should be noted that the functionality described herein as being performed by the browser 218 may be performed by any other application capable of rendering Web content. Any and all such variations, and any combination thereof, are contemplated to be within the scope of embodiments of the present invention.

The search engine 212 is configured to receive and respond to requests that it receives from components associated with user computing devices, for instance, the browser 218 associated with the user computing device 210. Those skilled in the art of the present invention will recognize that the present invention may be implemented with any number of searching utilities. For example, an Internet search engine or a database search engine may utilize the present invention. These search engines are well known in the art, and commercially available engines share many similar processes not further described herein.

As illustrated, the search engine 212 includes a request receiving component 222, a user action detecting component 224 and a presentation component 226. The illustrated search engine 212 also has access to a data store 214. The data store 214 is configured to store information pertaining to, in part, images for presentation as background images and search queries. In various embodiments, such information may include, without limitation, image data, video data, additional information relevant to the image data and/or video data, and search query logs. In embodiments, the data store 214 is configured to be searchable for one or more of the items stored in association therewith. It will be understood and appreciated by those of ordinary skill in the art that the information stored in association with the data store 214 may be configurable and may include any information relevant to images for display as background images on search engine homepages and search queries. The content and volume of such information are not intended to limit the scope of embodiments of the present invention in any way. Further, though illustrated as a single, independent component, the data store 214 may, in fact, be a plurality of storage devices, for instance a database cluster, portions of which may reside in association with the search engine 212, the client computing device 210, another external computing device (not shown), and/or any combination thereof.

The request receiving component 222 of the search engine 212 is configured to receive requests for presentation of search engine homepages. Typically, such a request is received via a browser associated with a client computing device, for instance, the browser 218 associated with the user computing device 210. It should be noted, however, that embodiments of the present invention are not limited to users inputting a search query into a traditional query-input region of a screen display.

Upon receipt of a request for presentation of a search engine homepage, the search engine 212 transmits the web page associated with the search engine homepage for presentation, for instance, in association with the display 220 of the user computing device 210. Associated with the search engine homepage is a background image having a plurality of hidden user interface elements, as more fully described below.

The user action detecting component 224 is configured to detect one or more user actions taken with respect to a presented background image of the search engine homepage. Such actions may include, by way of example only, movement of a mouse pointer or cursor over an area of the presented image, clicking on an area of the presented image, or tapping on an area of the presented image. In embodiments, the user action detecting component 224 is also configured to detect a predefined period of inactivity with respect to the search engine homepage. As more fully described below, such inactivity may cause one or more user interface elements to be surfaced in an effort to entice users to engage with the homepage.

The user action detecting component 224 is further configured to detect one or more user actions taken with respect to an exposed user interface element associated with a presented background image of a search engine homepage. In this instance, such user actions may include, by way of example only, a hover action within a predefined proximity to a user interface element, clicking within a predefined proximity to a user interface element, or tapping within a predefined proximity to a user interface element.

The presentation component 226 of the search engine 212 is configured to transmit for presentation, for instance, in association with the display 220 of the user computing device 210, search engine homepages having background images associated therewith, user interface elements associated with search engine homepage background images, and additional information segments (or portions thereof) associated with such user interface elements.

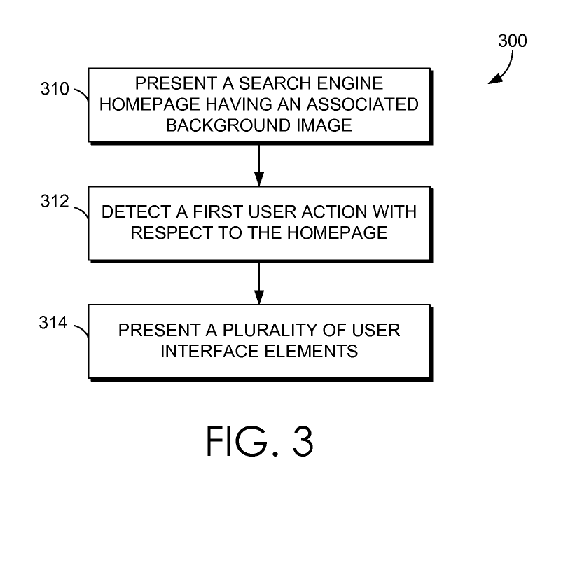

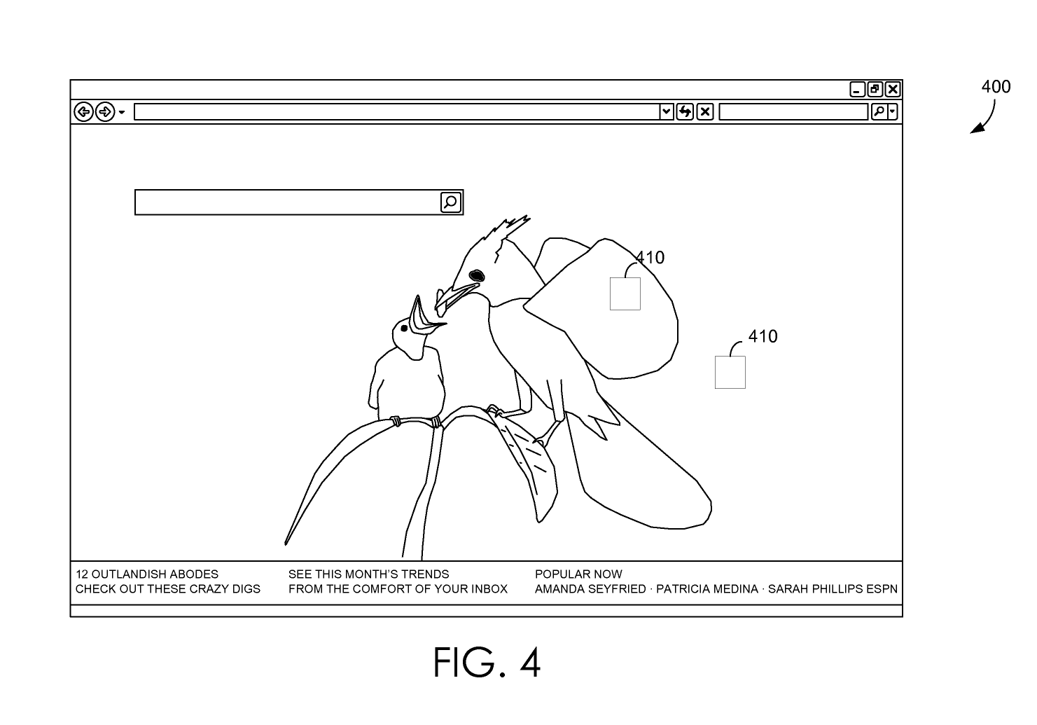

Turning now to FIG. 3, a flow diagram is illustrated showing an exemplary method 300 for exposing hidden user interface elements associated with search engine homepages, in accordance with an embodiment of the present invention. As indicated at block 310, a search engine homepage having a background image associated therewith is presented, for instance, in association with the display 220 of the user computing device 210 of FIG. 2. A first user action is then detected with respect to the presented search engine homepage (for instance, utilizing the user action detecting component 224 of FIG. 2), as indicated at block 312. The first user action may include, by way of example only, a movement of a mouse or cursor over a specified portion of the background image of the search engine homepage, a click on a specified portion of the background image and/or a tap on a specified portion of the background image. Upon detecting the first user action, a plurality of user interface elements is presented, as indicated at block 314. An exemplary screen display 400 of a plurality of user interface elements 410 being presented upon detecting a user action with respect to a background image of a search engine homepage is shown in FIG. 4. In embodiments, a predefined period of user inactivity with respect to the search engine homepage may be considered a user action such that such inactivity causes the plurality of user interface elements to be surfaced in an effort to entice users to engage with the homepage.

Each user interface element is associated with an additional information segment relevant to the background image presented. Such additional information segments may be textual information about the background image or a specified portion thereof, links to additional information relevant to the background image or a specified portion thereof, or the like.

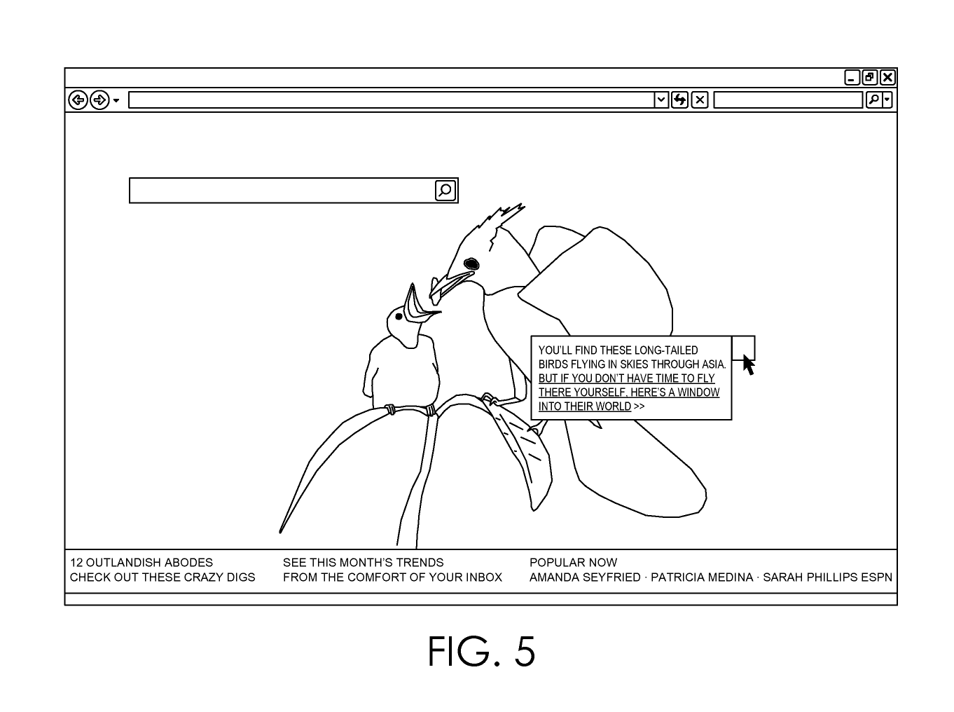

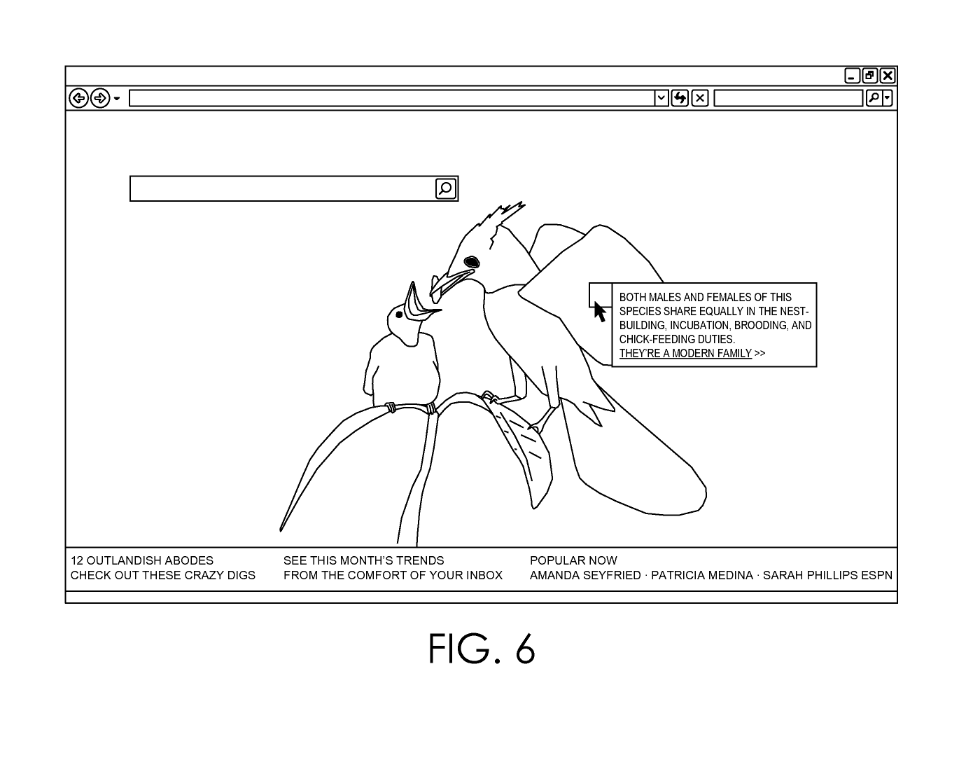

Though not illustrated in FIG. 3, a second user action with respect to a particular user interface element of the plurality of user interface elements presented in association with the background image of the search engine homepage may be detected (for instance, utilizing the user action detecting component 224 of FIG. 2). The second user action may include, by way of example only, a hover action over a region of the background image that is within a predefined proximity to the particular user interface element, a click on a region of the background image that is within a predefined proximity to the particular user interface element, or a tap on a region of the background image that is within a predefined proximity to the particular user interface element. In embodiments, upon detecting the second user action, the plurality of user interface elements other than the particular user interface element cease to be presented and at least a portion of the additional information segment associated with the particular user interface element is presented. This is shown in the screen displays of FIGS. 5 and 6 (each showing an additional information segment associated with a different user interface element).

In another embodiment, upon detecting the second user action, the additional information segments associated with each of the plurality of user interface elements is simultaneously presented. In another embodiment, upon detecting the second user action, teaser information segments that are less robust than the additional information segments may be presented in association with each of the plurality of user interface elements. In such embodiments, users are enticed to interact with the search engine homepage and are able to easily determine which additional information segments s/he finds most interesting.

In embodiments, upon detecting a cessation of the second user action (for instance, upon the user ceasing to hover the mouse pointer within a specified proximity of a user interface element) and/or expiration of a predefined time period during which there is a lack of user activity with respect to the search engine homepage, presentation of the additional information segment associated with the particular user interface element (or all user interface elements) is caused to cease. In embodiments, each of the plurality of user interface elements including the particular user interface element are again presented in association with the search engine homepage background image. Upon detecting a cessation of the first user action (for instance, upon the user ceasing to move the mouse pointer relative to the background image of the search engine homepage) and/or expiration of a predefined time period during which there is a lack of user activity with respect to the search engine homepage, presentation of the plurality of user interface elements may be caused to cease leaving the user with an unobstructed search engine homepage.

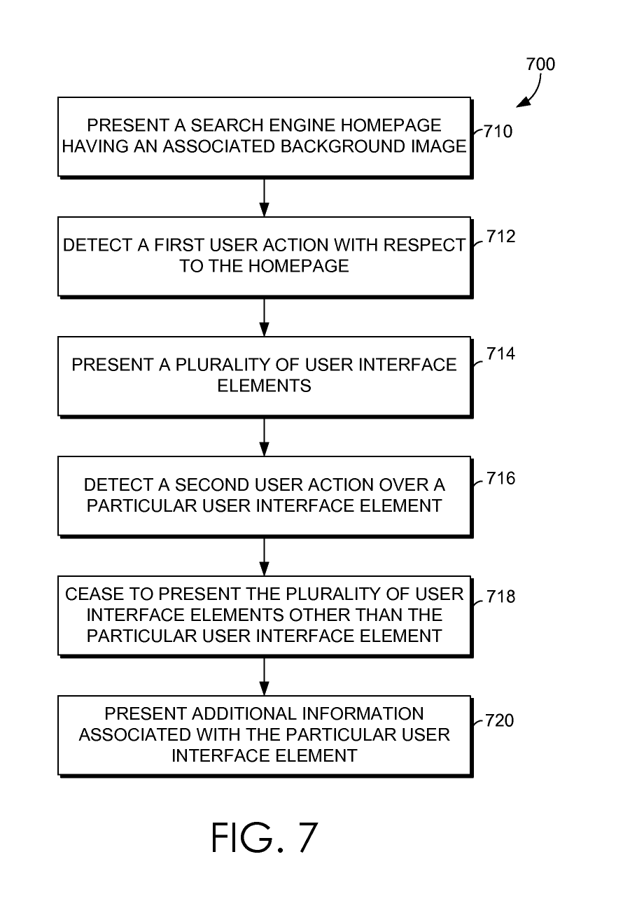

Turning now to FIG. 7, a flow diagram is illustrated showing an exemplary method 700 for exposing hidden (e.g., embedded) user interface elements associated with search engine homepages. As indicated at block 710, a search engine home page is presented, the search engine homepage having a background image associated therewith. As indicated at block 712, a first user action with respect to the presented search engine homepage is detected and, upon detecting the first user action, a plurality of user interface elements is presented, as indicated at block 714. A second user is detected with respect to a region of the background image that is within a predefined proximity to a particular user interface element of the plurality of user interface elements, as indicated at block 716. Upon detecting the second user action, presentation of the plurality of user interface elements other than the particular user interface element is caused to cease. This is indicated at block 718. At least a portion of the additional information segment associated with the particular user interface element is presented, as indicated at block 720.

As can be understood, embodiments of the present invention provide systems and methods for exposing hidden user interface elements associated with search engine homepages. The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 600 of FIGS. 6 and 700 of FIG. 7 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for exposing hidden user interface elements associated with search engine homepages, the method comprising:
presenting a search engine homepage having a background image associated therewith;
detecting a first user action with respect to the presented search engine homepage; and
upon detecting the first user action, presenting a plurality of user interface elements, each user interface element being associated with an additional information segment relevant to the background image.

2. The one or more computer-readable storage media of claim 1, wherein detecting a first user action comprises detecting one or more of a movement of a mouse or cursor, a click, or a tap.

3. The one or more computer-readable storage media of claim 1, wherein the method further comprises:
detecting a second user action with respect to a particular user interface element of the plurality of user interface elements; and
upon detecting the second user action, causing the plurality of user interface elements other than the particular user interface element to cease to be presented.

4. The one or more computer-readable storage media of claim 3, wherein detecting a second user action comprises detecting a hover action, a click, and/or a tap over a region of the background image that is within a predefined proximity to the particular user interface element.

5. The one or more computer-readable storage media of claim 4, wherein the method further comprises presenting at least a portion of the additional information segment associated with the particular user interface element.

6. The one or more computer-readable storage media of claim 5, wherein the additional information segment is relevant to a portion of the background image within a predefined proximity to the particular user interface element.

7. The one or more computer-readable storage media of claim 5, wherein the method further comprises:
detecting one of a cessation of the second user action or the expiration of predefined period of time; and
upon detecting the cessation of the second user action or the expiration of the predefined period of time, causing presentation of the additional information segment associated with the particular user interface element to cease, and causing presentation of all of the plurality of user interface elements.

8. The one or more computer-readable storage media of claim 1, wherein the plurality of user interface elements are embedded in the search engine home page.

9. The one or more computer-readable storage media of claim 1, wherein the additional information segments are embedded in the search engine home page.

10. A system for facilitating discoverability of user interface elements associated with search engine homepages, the system comprising:
a computing device associated with a server having one or more processors and one or more computer-readable storage media; and
a data store coupled with the server,
wherein the server:
detects a first user action with respect to a presented search engine homepage, the search engine homepage having an associated background image;
upon detecting the first user action, presents a plurality of user interface elements, each of the plurality of user interface elements being associated with an additional information segment relevant to the background image;
detecting a second user action with respect to a particular user interface element of the plurality of user interface elements; and
upon detecting the second user action, presents the additional information segments associated with each of the plurality of user interface elements.

11. The system of claim 10, wherein the first user action comprises at least one of a movement of a mouse or cursor, a click, and a tap.

12. The system of claim 10, wherein the second user action comprises a hover action, a click, and/or a tap over a region of the background image that is within a predefined proximity to the particular user interface element.

13. The system of claim 10, wherein each additional information segment is relevant to a portion of the background image within a predefined proximity to the associated user interface element.

14. The system of claim 10, wherein the server further:
detects one of a cessation of the second user action or the expiration of a predefined period of time; and
upon detecting the cessation of the second user action or upon the expiration of the predefined period of time, causes presentation of the additional information segments associated with each of the plurality of user interface elements to cease.

15. The system of claim 14, wherein the server further:
detects one of a cessation of the first user action or the expiration of a predefined period of time; and
upon detecting the cessation of the first user action or the expiration of the predefined period of time, causes presentation of the plurality of user interface elements to cease.

16. The system of claim 10, wherein at least one of the plurality of user interface elements and the additional information segments is embedded in the search engine home page.

17. A method being performed by one or more computing devices including at least one processor, for exposing hidden user interface elements associated with search engine homepages, the method comprising:
presenting a search engine homepage having a background image associated therewith;
detecting a first user action with respect to the presented search engine homepage;
upon detecting the first user action, presenting a plurality of user interface elements, each user interface element being associated with an additional information segment relevant to the background image;
detecting a second user action over a region of the background image that is within a predefined proximity to a particular user interface element of the plurality of user interface elements;
upon detecting the second user action, causing the plurality of user interface elements other than the particular user interface element to cease to be presented; and
presenting at least a portion of the additional information segment associated with the particular user interface element.

18. The method of claim 17, wherein the additional information segment is relevant to a portion of the background image that is near the particular user interface element.

19. The method of claim 17, wherein the method further comprises:
detecting one of a cessation of the second user action or the expiration of a predefined period of time; and
upon detecting the cessation of the second user action or the expiration of the predefined period of time, causing presentation of the additional information segment associated with the particular user interface element to cease, and causing presentation of all of the plurality of user interface elements.

20. The method of claim 17, wherein at least one of the plurality of user interface elements and the additional information segments is embedded in the search engine home page.
